(19) United States
(12) Patent Application Publication
(10) Pub. No.: US 2013/0014113 A1
(43) Pub. Date: Jan. 10, 2013

(54) MACHINE OPERATION PLAN CREATION DEVICE, MACHINE OPERATION PLAN CREATION METHOD AND MACHINE OPERATION PLAN CREATION PROGRAM

(75) Inventor: Yasuhiro Ajiro, Tokyo (JP)

(73) Assignee: NEC CORPORATION, TOKYO (JP)

(21) Appl. No.: 13/636,942

(22) PCT Filed: Mar. 14, 2011
(86) PCT No.: PCT/JP2011/055883

§ 371 Date: Sep. 24, 2012

(30) Foreign Application Priority Data
Mar. 25, 2010 (JP) 2010-069229

(51) Int. Cl. G06F 9/46

(52) U.S. Cl. 718/100

(57) ABSTRACT

An operation plan of a minimum number of servers (processing nodes) required for satisfying performance requirement is created, and servers that need not to be operated are powered off to save power and computing resources. Specifically, a machine operation plan creation device compares a machine ID numbered in order starting from 1 with an hourly required machine count and, if the machine ID is not larger, determines that the machine needs to be operated. If each machine has plural hours, the plural hours are merged to reduce the number of hours. Here, if two hours are temporally continuous, the two hours are merged into a new hour. Alternatively, a start time of the first hour and an end time of the last hour are extracted from the plural hours, and a time period from the start time to the end time is set as a new hour. Moreover, a maximum required machine count is calculated from an hourly required machine count list.

### TECHNICAL FIELD

The present invention relates to a machine operation plan creation device and particularly to a machine operation plan creation device for creating an operation plan of a server of a Web system and the like.

### BACKGROUND ART

Patent Literature 1 (Japanese Patent No. 3003440) discloses an operation plan creation supporting function as a part of a load balancing control method. The load balancing here means appropriately allocating plural kinds of workload to a plurality of processing nodes for handling. The load balancing control method disclosed in Patent Literature 1 prepares plural kinds of workload mapping tables each defining which workload is allocated to which node, and determines, based on an operation management table defining which workload mapping table should be referred to with respect to each hour, which node should handle a request received from a user of nodes. As a result, it is possible to flexibly disperse respective workload that varies depending on hour.

The operation plan creation supporting function is a function of supporting creation of the workload mapping tables and the operation management table. This function provides a load characteristics definition screen that defines and shows how much each workload with respect to each hour is and a simulator screen that shows what a load factor of each node would be as a result of manual work allocation by a user. Since the user can consider the work allocation with respect to each hour by trial and error by referring to these screens, the user can quickly find allocation with which the loads of respective nodes are equalized.

Patent Literature 2 (Japanese Patent Application Publication JP-2005-141441) discloses a service server operation plan table used by a load balancing system. A management server device of the load balancing system sets, based on access statistics in each hour, the number of distribution servers to which requests are distributed and addresses for the respective servers. As a method of allocating servers here, a method that always allocates in ascending order of addresses and a rotation method that allocates servers based on an address of a latest allocated server are described.

A problem with Patent Literature 1 is that while receiving the support from a computer, the user needs to create the operation plan of servers (processing nodes) by trial and error.

A problem with Patent Literature 2 is that since an allocation destination is determined based on an IP address, the operation plan of a server having a plurality of IP addresses and a server to which no IP address is assigned cannot be created. Moreover, there is another problem that since the IP address is not a simple numerical value, an operation for comparing the IP address needs to be defined separately.

### CITATION LIST

### Patent Literature

[Patent Literature 1] Japanese Patent No. 3003440
[Patent Literature 2] Japanese Patent Application Publication JP-2005-141441

### SUMMARY OF INVENTION

An object of the present invention is to provide a machine operation plan creation device that creates an operation plan based on a minimum number of servers required for satisfying performance requirement, without referring to such an identifier as an IP address.

A machine operation plan creation device according to the present invention has: an hourly required machine count storage unit configured to store an hourly required machine count; and an operation hour determination processing unit configured to compare a machine identifier numbered in order starting from 1 with the hourly required machine count and to determine, if the machine identifier is not larger, that the machine associated with the machine identifier needs to be operated.

A machine operation plan creation method according to the present invention includes: comparing a machine identifier numbered in order starting from 1 with an hourly required machine count; and determining, if the machine identifier is not larger, that the machine associated with the machine identifier needs to be operated.

A machine operation plan creation program according to the present invention is a program that causes a computer to execute the above-described machine operation plan creation method. It should be noted that the machine operation plan creation program according to the present invention can be stored in a storage device or a recording medium.

It is possible to save power consumption and computing resources by shutting down machines that need not to be operated for satisfying performance requirement.

### BRIEF DESCRIPTION OF DRAWINGS

FIG. 1 is a block diagram showing a configuration of a machine operation plan creation device in a first exemplary embodiment of the present invention.

FIG. 2A is a diagram showing an example of hourly required throughput represented on a table.

FIG. 2B is a diagram showing an example of hourly required machine count represented on a table.

FIG. 3 is a flow chart showing processing by the machine operation plan creation device in the first exemplary embodiment.

FIG. 4 is a diagram showing an example of an operation hour determination result (operation plan) in a case where a machine is a virtual machine (VM).

FIG. 5 is a block diagram showing a configuration of an operation plan creation processing unit in a second exemplary embodiment of the present invention.

FIG. 6 is a flow chart showing processing by the operation plan creation processing unit in the second exemplary embodiment.

FIG. 7 is a flow chart showing processing by the operation plan creation processing unit in the second exemplary embodiment.

FIG. 8A is a diagram showing an example of a merging result in a case where first merging processing is used in the second exemplary embodiment.

FIG. 8B is a diagram showing an example of a merging result in a case where second merging processing is used in the second exemplary embodiment.

### DESCRIPTION OF EMBODIMENTS

### First Exemplary Embodiment

A first exemplary embodiment of the present invention will be described below with reference to the attached drawings.

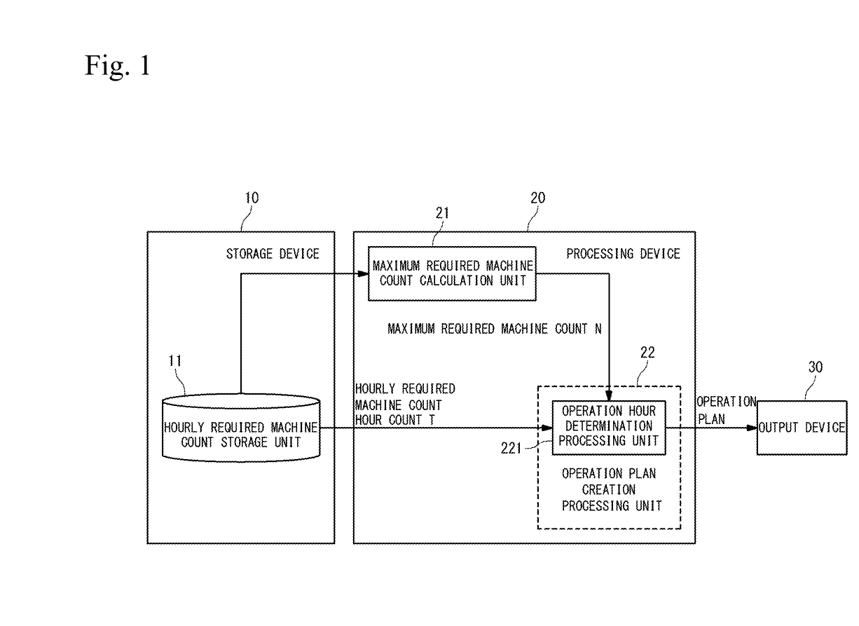

As shown in FIG. 1, a machine operation plan creation device in the first exemplary embodiment of the present invention has a storage device 10, a processing device 20 and an output device 30.

The storage device 10 has an hourly required machine count storage unit 11.

The hourly required machine count storage unit 11 stores data on an hourly required machine count.

The hourly required machine count is a value indicating how many machines are required during each hour.

Usually, the hourly required machine count is derived from data on hourly required throughput. The hourly required throughput is a value indicating how much throughput is required during each hour.

The “machine” here is a physical machine (PM: Physical Machine) having physical substance or a virtual machine (VM: Virtual Machine) that is achieved based on software and constructed on a physical machine by a virtualization technology. When used as servers, the physical machine and the virtual machine are called a physical server and a virtual server, respectively.

A server providing a Web service and the like performs predetermined processing in response to a request issued by a client and returns a result of the processing as a response back to the client. The throughput (TP: Throughput) indicates the number of requests handled by a server per unit time (1 sec or 1 min, for example), and its unit is tps (transactions per second), tpm (transactions per minute) or the like.

When a machine having predetermined resources regarding a processor, a memory and the like provides a predetermined service at a predetermined level of quality, the throughput of the machine is almost constant. If required throughput cannot be achieved by one machine (a single machine), a plurality of machines is prepared and clustered. Each of the plurality of clustered machines performs load balancing that distributes the request processing among the cluster.

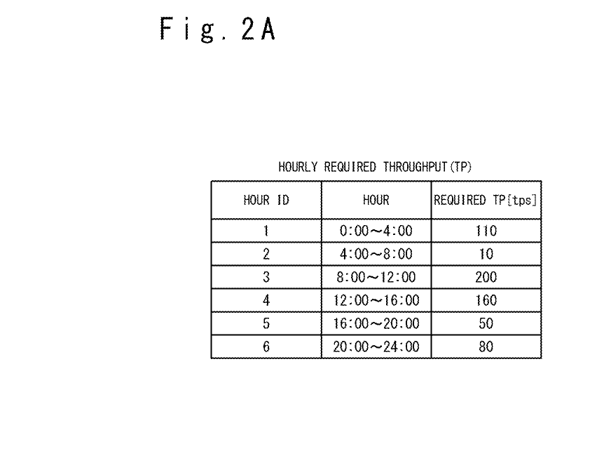

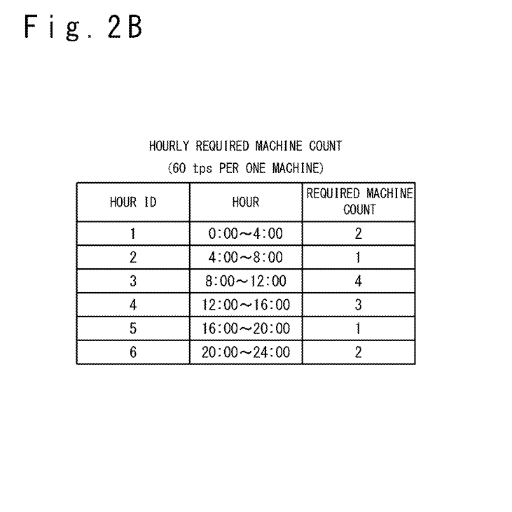

FIG. 2A shows an example of hourly required throughput represented on a table. FIG. 2B shows an example of hourly required machine count represented on a table. For convenience of processing, unique IDs (identifiers) are given to respective hours.

The example shown in FIG. 2A and FIG. 2B indicates a relationship between the hourly required throughput (FIG. 2A) and the hourly required machine count (FIG. 2B) in a case where the throughput of one machine is assumed to be “60 tps”. For example, in a case of hour 1 (0:00 to 4:00) where the hourly required throughput is “110 tps” and the performance of “60 tps” can be obtained by one machine, the hourly required machine count is “2” that is obtained by rounding up “110/60”. Here, the hour 1 means an hour with the hour ID of “1”.

The processing device 20 has a maximum required machine count calculation unit 21 and an operation plan creation processing unit 22.

The maximum required machine count calculation unit 21 obtains the data on the hourly required machine count and calculates a maximum required machine count N that is the maximum value of the required machine counts regarding the respective hours.

The operation plan creation processing unit 22 obtains the hourly required machine count, an hour count and the maximum required machine count.

The operation plan creation processing unit 22 has an operation hour determination processing unit 221.

The operation hour determination processing unit 221 creates an operation plan based on the hourly required machine count, the hour count and the maximum required machine count.

The output device 30 receives the operation plan from the processing device 20 and displays/prints/saves the operation plan. Alternatively, the output device 30 may perform processing depending on content of the operation plan. For example, the output device 30 may power off and shut down a machine that needs not to be operated for satisfying performance requirement. If the output device 30 itself is determined to be the machine that needs not to be operated, the output device 30 may receive, from the processing device 20, a power OFF instruction (command) or a power-OFF signal based on the operation plan to shut down.

[Examples of Hardware]

The machine operation plan creation device is exemplified by a computer such as a PC (personal computer), an appliance, a thin client server, a workstation, a main frame and a supercomputer. It should be noted that the machine operation plan creation device may be a virtual machine (VM) operating on a physical machine.

The storage device 10 is exemplified by a semiconductor memory device such as a RAM (Random Access Memory), a ROM (Read Only Memory), an EEPROM (Electrically Erasable and Programmable Read Only Memory) and a flash memory, an auxiliary storage device such as an HDD (Hard Disk Drive) and an SSD (Solid State Drive) and a recording medium such as a removal disk such as a DVD (Digital Versatile Disk) and an SD memory card (Secure Digital memory card). The storage device 10 is not limited to a storage device built in the computer but can be a peripheral device (e.g. an external HDD), a storage device of an external server (e.g. a Web server, a file server), or a storage device using a DAS (Direct Attached Storage), an FC-SAN (Fibre Channel-Storage Area Network), an NAS (Network Attached Storage), an IP-SAN (IP-Storage Area Network) and the like. The storage device 10 may be a register.

The processing device 20 is exemplified by a CPU (Central Processing Unit), a microprocessor, a microcontroller, a semiconductor integrated circuit (Integrated Circuit (IC)) having a special function, and the like.

The storage device 10 and the processing device 20 may be integrated. For example, in recent years, a microcomputer has been integrated into one chip. Accordingly, a case can be contemplated in which the 1-chip microcomputer mounted in the machine operation plan creation device of the present invention includes the storage device 10 and the processing device 20.

Alternatively, the storage device 10 and the processing device 20 may be respectively achieved by independent computers.

The output device 30 is exemplified by a display device such as an LCD (Liquid Crystal Display), a PDP (Plasma Display Panel) and an organic EL display (organic electroluminescence display), a printing device such as a printer that prints output content on a sheet, or a projecting device such as a projector that projects output content onto a wall or a screen. Alternatively, the output device 30 may be an interface (I/F: interface) for outputting information to an external display device or an external storage device. The output device 30 may be another computer.

The maximum required machine count calculation unit 21 and the operation plan creation processing unit 22 each is a functional unit module. The maximum required machine count calculation unit 21 and the operation plan creation processing unit 22 are achieved by a processor operating and executing specified processing based on a program and a memory for storing the program and a variety of data. Alternatively, the maximum required machine count calculation unit 21 and the operation plan creation processing unit 22 may be a semiconductor integrated circuit (IC) having a special function.

In practice, however, it is not limited to these examples.

[Machine Operation Plan Creation Processing]

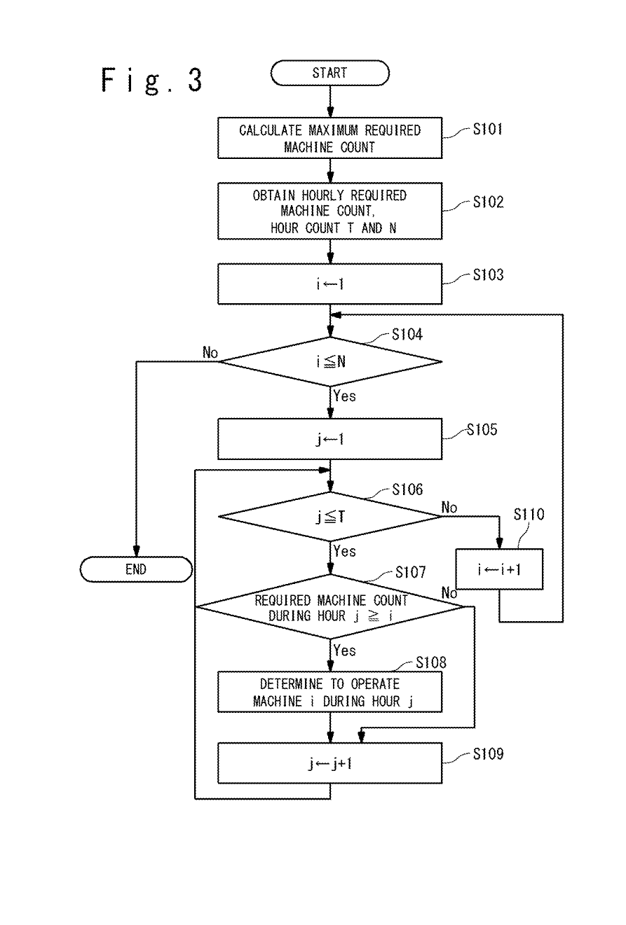

Machine operation plan creation processing according to the present exemplary embodiment will be described with reference to FIG. 3.

Here, let us consider a case where the hourly required machine count is beforehand stored in the hourly required machine count storage unit 11 of the storage device 10.

(1) Step S101

First, the maximum required machine count calculation unit 21 obtains the data of the hourly required machine count and calculates the maximum required machine count N being the maximum value that is the maximum value of the required machine counts regarding the respective hours. In the example shown in FIGS. 2A and 2B, the maximum required machine count N is “4” (N=4) that is the required machine count during hour 3 (8:00 to 12:00).

(2) Step S102

Next, the operation plan creation processing unit 22 obtains the hourly required machine count, an hour count T and the maximum required machine count N. The hour count T indicates the number of hours. In the example shown in FIGS. 2A and 2B, the hour count T is “6” (T=6) that is a total number of entries of the hour.

The operation hour determination processing unit 221 being a part of the operation plan creation processing unit 22 performs processing following Step S103 to create the operation plan. In the processing following Step S103, i whose maximum value is N (1≦i≦N) and j whose maximum value is T (1≦j≦T) are used for determining, if the required machine count during the hour j is X, that the machines 1 to X need to be operated. Based on a result of the determination, the processing device 20 executes the operation of machines 1 to X. Here, i is a variable indicating a machine ID. The machine ID is assigned one by one in ascending order from 1 to N. The machine i means a machine whose machine ID is i. Also, j is a variable indicating the hour ID. The hour ID is assigned one by one in ascending order from 1 to T. The hour j means an hour whose hour ID is j.

(3) Step S103

The operation hour determination processing unit 221 initializes i by assigning 1 to i.

(4) Step S104

The operation hour determination processing unit 221 checks whether or not a condition “i≦maximum required machine count N” is met. If the condition “i≦maximum required machine count N” is met, the processing proceeds to Step S105. If the condition “i≦maximum required machine count N” is not met and a condition “i>maximum required machine count N” is met, the operation hour determination processing unit 221 terminates the processing and outputs an operation hour determination result as the operation plan.

(5) Step S105

The operation hour determination processing unit 221 initializes j by assigning 1 to j.

(6) Step S106

The operation hour determination processing unit 221 checks whether or not a condition “j≦hour count T” is met. If the condition “j≦hour count T” is met, the processing proceeds to Step S107. If the condition “j≦hour count T” is not met, the processing proceeds to Step S110.

(7) Step S107

The operation hour determination processing unit 221 checks whether or not “the required machine count during the hour j is equal to or larger than i”. If “the required machine count during the hour j is equal to or larger than i” the processing proceeds to Step S108. If “the required machine count during the hour j is smaller than i”, the processing proceeds to Step S109.

(8) Step S108

The operation hour determination processing unit 221 determines that if the required machine count during the hour j is equal to or larger than i″, the machine i needs to be operated during the hour j. For example, in a case of “i=1”, the machine 1 is determined to be operated during the hour j.

(9) Step S109

The operation hour determination processing unit 221 increases (increments) the value of j by 1. After that, the processing proceeds to Step S106.

(10) Step S110

The operation hour determination processing unit 221 increases (increments) the value of i by 1. After that, the processing proceeds to Step S104.

In the above description, the loop regarding “i≦N” is first executed, within which the loop regarding “j≦T” is executed. As a result, whether or not a machine needs to be operated during each hour is determined for all the hours with respect to each machine (one by one). However, in practice, it is also possible to first execute the loop regarding “j≦T” within which the loop “i≦N” is executed. In this case, whether or not each machine needs to be operated during an hour is determined for all the machines with respect to each hour. That is to say, Step S103 and Step S105 may be interchanged, Step S104 and Step S106 may be interchanged and Step S109 and Step S110 may be interchanged. In either case, there is essentially no difference.

[Details of Operation Hour Determination Processing]

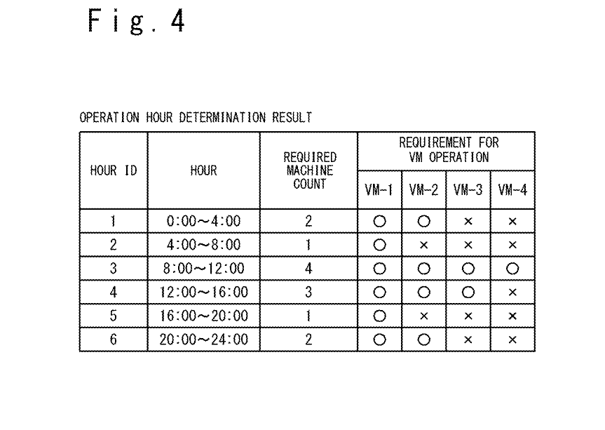

A concrete example of the processing following Step S103 in FIG. 3 will be described by using the example shown in FIGS. 2A and 2B. In the present example, “the maximum required machine count N=4, and the hour count T=6”. FIG. 4 shows an example of the operation hour determination result (operation plan) in a case where the machine is a virtual machine (VM).

In Step S103, the operation hour determination processing unit 221 initializes the value of i, which is the variable indicating the machine ID, to 1 (i=1). In the following Step S104, “i=1, N=4” and thus the condition “i≦N” (1≦4) is met. Therefore, the operation hour determination processing unit 221 executes Step S105 to initialize the value of j, which is the variable indicating the hour ID, to 1 (j=1).

In the following Step S106, “j=1, T=6” and thus the condition “j≦T” (1≦6) is met. Therefore, the operation hour determination processing unit 221 performs the determination in Step S107. In Step S107, “the required machine count during the hour 1=2, i=1” and thus the condition “the required machine count during the hour j≦i” (2≦1) is met. In the following Step S108, the operation hour determination processing unit 221 determines that the machine 1 needs to be operated during the hour 1.

In the following Step S109, the operation hour determination processing unit 221 increases the value of j by 1 (j=2). Then, with regard to the hour 2, the operation hour determination processing unit 221 executes the processing following Step S106 in a similar manner. In the case of “j=2”, the operation hour determination processing unit 221 determines in Step S108 that the machine 1 needs to be operated during the hour 2. The same applies to cases of “j=3 to 6”. That is, the operation hour determination processing unit 221 determines in Step S108 that the machine 1 needs to be operated during the hours 3 to 6.

A column of VM-1 in the table shown in FIG. 4 represents the execution result in the case of “i=1”. The VM-1 corresponds to the machine 1. A mark “∘” in the table means that the machine needs to be operated, and a mark “×” in the table means that the machine needs not to be operated.

When the loop following Step S106 is executed for six times and “j=7”, the status in Step S106 is “j=7, T=6” and “j>T” (7>6). Since the condition “j≦T” is not met, the operation hour determination processing unit 221 executes Step S110 to increase the value of i by 1, resulting in “i=2”. After that, the operation hour determination processing unit 221 executes the loop following Step S104 again.

In the cases of “the variable i=2 to 4”, columns of VM-2 to VM-4 in FIG. 4 are obtained by the processing of the loop following Step S104. The VM-2 to VM-4 correspond to the machines 2 to 4, respectively. In the subsequent loop where “i=5”, the status in Step S104 is “i=5, N=4” and “i>N” (5>4). Since the condition “i≦N” is not met, the operation hour determination processing unit 221 terminates the whole processing. In this manner, the all columns of VM-1 to VM-4 in FIG. 4 can be obtained.

After the completion of the operation hour determination processing described above, the processing device 20 outputs the obtained operation hour determination result as the operation plan to the output device 30. Alternatively, the processing device 20 may output an instruction (command) or a signal based on the obtained operation hour determination result as the operation plan to the output device 30.

By the above-described procedure based on the hourly required machine count and the machine ID, the operation plan indicating the machine that needs to be operated and the machine that needs not to be operated is provided. By referring to this information, it is possible to stop the machine that needs not to be operated for satisfying the performance requirement and thus to save power consumption and computing resources.

Another effect of the present invention is as follows. Since the machines operating during respective hours requiring the same number of machines are always the same, setting operations necessary for load balancing can be reduced. In the example shown in FIG. 4, the same plan that the machine 1 and the machine 2 are operated is created in both cases of the hour 1 and the hour 6 each requiring two machines.

In order to distribute requests received from a client for achieving the load balancing, it is necessary to configure a load balancing device called a load balancer to set which machines the requests should be distributed to with the IP address and the like of the machine. Therefore, in a case where two load balancers perform the load balancing, a different combination of the two load balancers requires different setting. Such waste can be eliminated according to the present invention.

### Second Exemplary Embodiment

A second exemplary embodiment of the present invention will be described below with reference to the attached drawings.

In the present exemplary embodiment, an operation hour merging result is created based on the operation hour determination result (operation plan) obtained in the first exemplary embodiment.

The present exemplary embodiment is different from the first exemplary embodiment in that the operation plan creation processing unit 22 further has an operation hour merging processing unit 222 in addition to the operation hour determination processing unit 221. The other features are the same as those of the first exemplary embodiment.

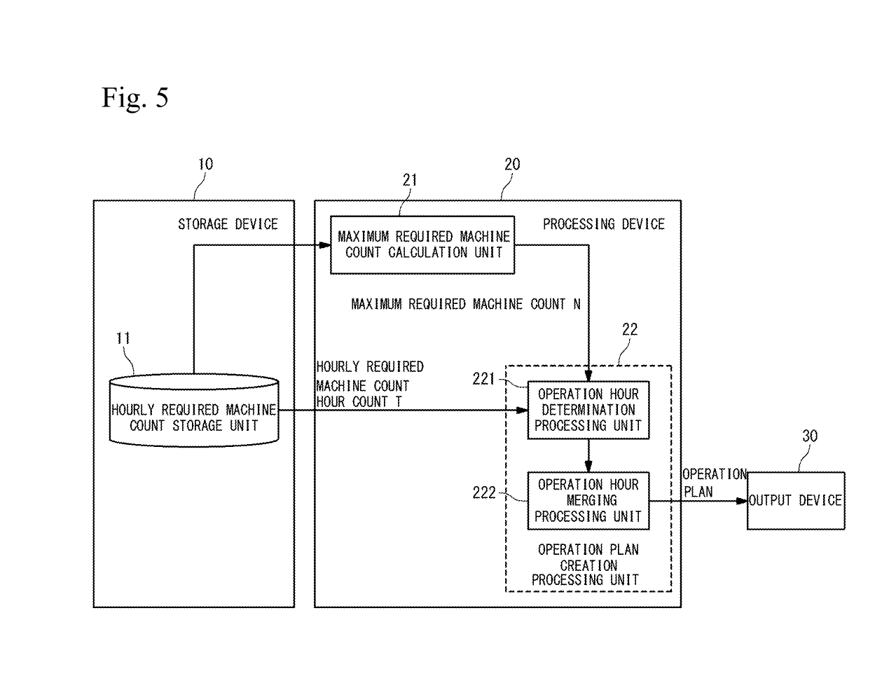

As shown in FIG. 5, the machine operation plan creation device in the second exemplary embodiment of the present invention has a storage device 10, a processing device 20 and an output device 30.

The storage device 10 and the output device 30 are basically the same as those in the first exemplary embodiment.

The processing device 20 has a maximum required machine count calculation unit 21 and an operation plan creation processing unit 22.

The operation plan creation processing unit 22 has an operation hour determination processing unit 221 and an operation hour merging processing unit 222.

The maximum required machine count calculation unit 21 and the operation hour determination processing unit 221 are basically the same as those in the first exemplary embodiment.

The operation hour merging processing unit 222 receives the operation hour determination result created by the operation hour determination processing unit 221 in the first exemplary embodiment and creates an operation hour merging result.

[Operation Hour Merging Processing]

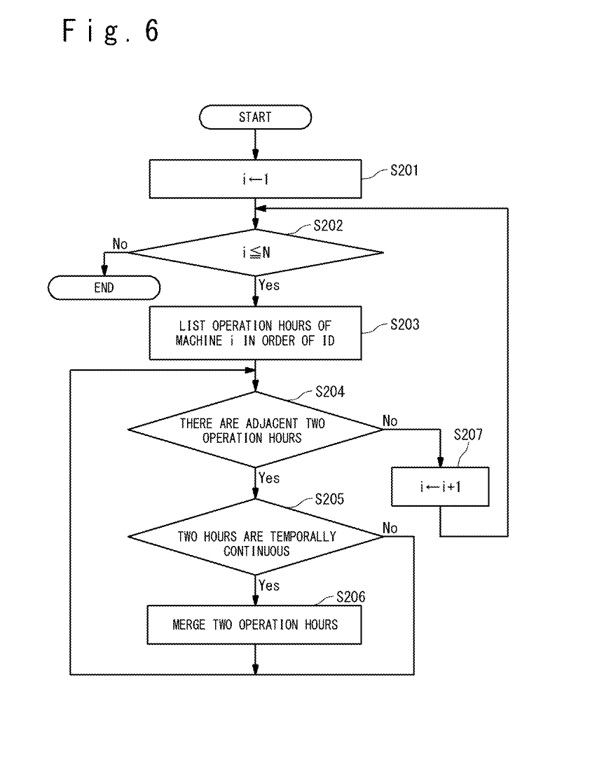

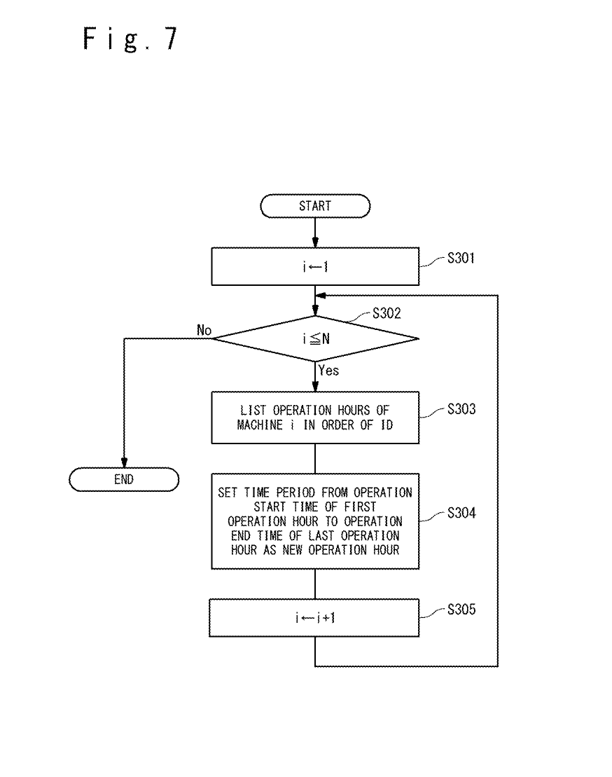

FIGS. 6 and 7 are flow charts respectively showing two kinds of processing performed by the operation hour merging processing unit 222 according to the present exemplary embodiment. FIG. 6 is a flow chart showing first merging processing. FIG. 7 is a flow chart showing second merging processing.

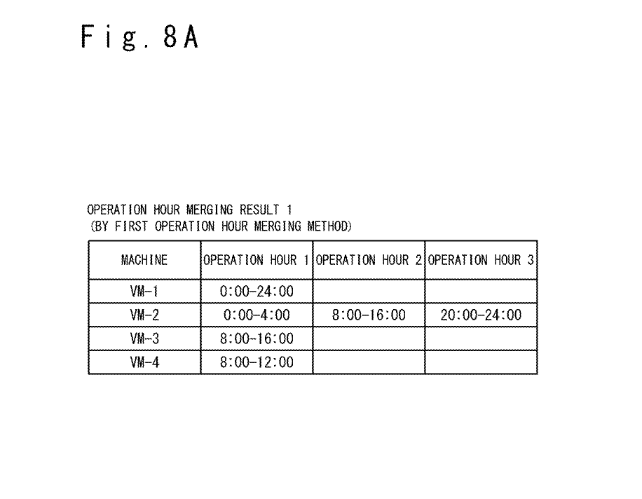

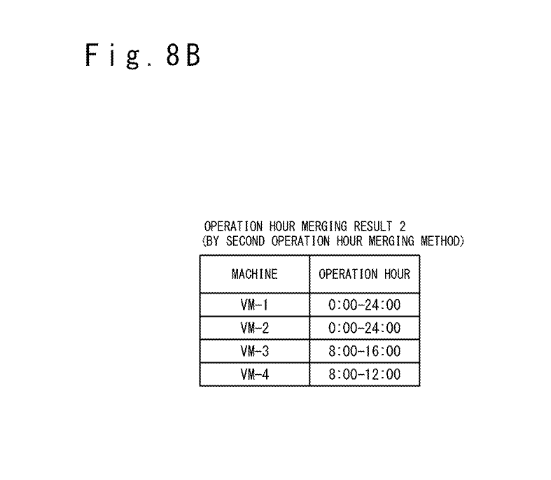

FIG. 8A shows a table representing a merging result obtained by using the first merging processing (FIG. 6) based on the operation hour determination result shown in FIG. 4 as an input. FIG. 8B shows a table representing a merging result obtained by using the second merging processing (FIG. 7) based on the operation hour determination result shown in FIG. 4 as an input.

[First Merging Processing]

The first merging processing will be first described with reference to FIG. 6.

(1) Step S201

The operation hour merging processing unit 222 initializes i by assigning 1 to i.

(2) Step S202

The operation hour merging processing unit 222 checks whether or not a condition “i≦maximum required machine count N” is met. If the condition “i≦maximum required machine count N” is met, the processing proceeds to Step S203. If the condition “i≦maximum required machine count N” is not met and a condition “i>maximum required machine count N” is met, the operation hour merging processing unit 222 terminates the processing and creates the operation hour determination result.

(3) Step S203

The operation hour merging processing unit 222 lists the operation hours of the machine i in order of ID. For example, the operation hour merging processing unit 222 lists the operation hours in ascending or descending order of the hour ID.

(4) Step S204

The operation hour merging processing unit 222 checks whether or not there are adjacent two operation hours. If there are two adjacent operation hours, the processing proceeds to Step S205. If there are not two adjacent operation hours, the processing proceeds to Step S207.

(5) Step S205

The operation hour merging processing unit 222 checks whether or not the adjacent two operation hours are temporally continuous. If the adjacent two operation hours are temporally continuous, the processing proceeds to Step S206. If the adjacent two operation hours are not temporally continuous, the processing proceeds to Step S204.

(6) Step S206

The operation hour merging processing unit 222 merges the adjacent two operation hours. After that, the processing proceeds to Step S204.

(7) Step S207

The operation hour merging processing unit 222 increases (increments) the value of i by 1. After that, the processing proceeds to Step S202.

[Second Merging Processing]

Next, the second merging processing will be described with reference to FIG. 7.

(1) Step S301

The operation hour merging processing unit 222 initializes i by assigning 1 to i.

(2) Step S302

The operation hour merging processing unit 222 checks whether or not a condition “i≦maximum required machine count N” is met. If the condition “i≦maximum required machine count N” is met, the processing proceeds to Step S303. If the condition “i≦maximum required machine count N” is not met and a condition “i>maximum required machine count N” is met, the operation hour merging processing unit 222 terminates the processing and creates the operation hour determination result.

(3) Step S303

The operation hour merging processing unit 222 lists the operation hours of the machine i in order of ID. For example, the operation hour merging processing unit 222 lists the operation hours in ascending or descending order of the hour ID.

(4) Step S304

The operation hour merging processing unit 222 sets a time period from an operation start time of the first operation hour to an operation end time of the last operation hour as a new operation hour. That is, the operation hour merging processing unit 222 merges all the operation hours from the first operation hour to the last operation hour.

(5) Step S305

The operation hour merging processing unit 222 increases (increments) the value of i by 1. After that, the processing proceeds to Step S302.

[Details of First Merging Processing]

Regarding a concrete example of the first merging processing shown in FIG. 6, a concrete example of the processing performed by the operation hour merging processing unit 222 according to the present exemplary embodiment will be described by using the example of the operation hour determination result shown in FIG. 4. In the present example, “the maximum required machine count N=4, and the hour count T=6”, as in the case of the first exemplary embodiment.

In Step S201, the operation hour merging processing unit 222 initializes i corresponding to the machine ID to 1 (i=1). In the following Step S202, “i=1, N=4” and thus the condition “i≦N” (1≦4) is met. Therefore, the operation hour merging processing unit 222 executes Step S203.

In Step S203, the operation hour merging processing unit 222 lists the operation hours of the machine 1 in order of ID.

In the case of the example shown in FIG. 4, the list of the operation hours in order of ID is as follows.

(1) hour 0:00 to 4:00

(2) hour 4:00 to 8:00

(3) hour 8:00 to 12:00

(4) hour 12:00 to 16:00

(5) hour 16:00 to 20:00

(6) hour 20:00 to 24:00

In the following Step S204, the operation hour merging processing unit 222 extracts adjacent two operation hours in order from the beginning. After that, in Step S205, the operation hour merging processing unit 222 determines whether or not the extracted two operation hours are continuous. First, the operation hour merging processing unit 222 extracts the hour 0:00 to 4:00 and the hour 4:00 to 8:00. Since the hour 0:00 to 4:00 and the hour 4:00 to 8:00 are temporally continuous, the condition of Step S205 is met. Therefore, in Step S206, the operation hour merging processing unit 222 merges the hour 0:00 to 4:00 and the hour 4:00 to 8:00 into an hour 0:00 to 8:00.

Returning back to Step S204 again, the operation hour merging processing unit 222 makes a determination of Step S205 with respect to the merged hour 0:00 to 8:00 and the adjacent hour 8:00 to 12:00. Since the hour 0:00 to 8:00 and the hour 8:00 to 12:00 are temporally continuous, the condition of Step S205 is met. Therefore, in Step S206, the operation hour merging processing unit 222 merges the hour 0:00 to 8:00 and the hour 8:00 to 12:00 into an hour 0:00 to 12:00.

The processing from Step S204 to Step S206 is repeated in a similar manner. As a result, the operation hour of the machine 1 is determined to be an hour 0:00 to 24:00. That is, the machine 1 is determined to operate constantly. A column of VM-1 in the table shown in FIG. 8A represents the operation hour of the machine 1 (VM-1) obtained as a result of the merging.

When the processing for the adjacent two hours is completed with regard to the machine 1, the condition of Step S204 is not met. Therefore, the operation hour merging processing unit 222 executes Step S207. In Step S207, the operation hour merging processing unit 222 increases the value of i by 1 (i=2) and executes the loop following Step S202 again.

In Step S202 with regard to the machine 2 (VM-2), “i=2, N=4” and thus the condition “i≦N” (2≦4) is met. Therefore, the operation hour merging processing unit 222 executes Step S203.

In Step S203, the operation hour merging processing unit 222 lists the operation hours of the machine 2 as follows.

(1) hour 0:00 to 4:00

(2) hour 8:00 to 12:00

(3) hour 12:00 to 16:00

(4) hour 20:00 to 24:00

In the following Step S204, the hour 0:00 to 4:00 and the hour 8:00 to 12:00 adjacent to each other are extracted. However, the hour 0:00 to 4:00 and the hour 8:00 to 12:00 are not temporally continuous. Therefore, the condition of Step S205 is not met and the processing returns back to Step S204.

In the second Step S204, the operation hour merging processing unit 222 makes a determination of Step S205 with respect to the hour 8:00 to 12:00 and the hour 12:00 to 16:00 adjacent to each other. Since the hour 8:00 to 12:00 and the hour 12:00 to 16:00 are temporally continuous, the condition of Step S205 is met. Therefore, the operation hour merging processing unit 222 merges the hour 8:00 to 12:00 and the hour 12:00 to 16:00 into an hour 8:00 to 16:00.

In the third Step S204, the operation hour merging processing unit 222 makes a determination of Step S205 with respect to the hour 8:00 to 16:00 and the hour 20:00 to 24:00 adjacent to each other. Since the hour 8:00 to 16:00 and the hour 20:00 to 24:00 are not temporally continuous, the condition of Step S205 is not met and the processing returns back to Step S204.

In the fourth Step S204, unprocessed adjacent hours no more exist. Therefore, in Step S207, the operation hour merging processing unit 222 increases the value of i by 1 (i=3) and executes the third loop following Step S202.

As a result, three hours: the hour 0:00 to 4:00, the hour 8:00 to 16:00 and the hour 20:00 to 24:00 are obtained with regard to the machine 2 (see column of VM-2 in FIG. 8A). It can be seen from this result that power-on times of the machine 2 are at 8:00 and at 20:00 and power-off times thereof are at 4:00 and at 16:00. Since it takes a time for the machine to be actually available after holding a power button down, the power-on time may be set to be earlier than 8:00 and 20:00 for the sake of margin.

After that, an hour 8:00 to 16:00 for the machine 3 and an hour 8:00 to 12:00 for the machine 4 are obtained as a result of the processing following Step S202. That is, the hour 8:00 to 16:00 is obtained in the case of “i=3” and the hour 8:00 to 12:00 is obtained in the case of “i=4”.

When “i=5” after completion of the processing with regard to the machine 4, the status in Step S202 is “i=5, N=4” and “i>N” (5>4). Since the condition “i≦N” is not met, the operation hour merging processing unit 222 terminates the whole processing.

As a result, the operation hour merging result for each machine (VM) is obtained as shown in the table in FIG. 8A.

The processing device 20 outputs the obtained operation hour merging result as the operation plan to the output device 30. Alternatively, the processing device 20 may output an instruction (command) or a signal based on the obtained operation hour determination result as the operation plan to the output device 30.

By merging the continuous operation hours of each machine by the above-described procedure, it is possible to save operation costs required for the power-on and the power-off. Moreover, if the power-on and the power-off are manually performed, an operation mistake may be caused. Furthermore, the power-on/off operation causes a negative effect that a machinery is physically consumed and a mechanical life is shortened. By referring to the operation hour merging result, it is possible to reduce risk of occurrence of failure of the machine and the operation mistake.

[Details of Second Merging Processing]

Next, regarding a concrete example of the first merging processing shown in FIG. 7, a concrete example of the processing performed by the operation hour merging processing unit 222 according to the present exemplary embodiment will be described by using the example of the operation hour determination result shown in FIG. 4. In the present example, “the maximum required machine count N=4, and the hour count T=6”, as in the case of the first merging processing.

The processing from Step S301 to Step S303 in FIG. 7 is the same as the processing from Step S201 to Step S203 in the first merging processing (FIG. 6).

In Step S303 in a case of “i=1”, the operation hour merging processing unit 222 lists the operation hours of the machine 1 in order of ID.

In Step S303, the operation hour merging processing unit 222 lists the operation hours of the machine 1 as follows.

(1) hour 0:00 to 4:00

(2) hour 4:00 to 8:00

(3) hour 8:00 to 12:00

(4) hour 12:00 to 16:00

(5) hour 16:00 to 20:00

(6) hour 20:00 to 24:00

In Step S304, the operation hour merging processing unit 222 extracts an operation start time 0:00 of the first hour 0:00 to 4:00 and an operation end time 24:00 of the last hour 20:00 to 24:00 to create a new hour 0:00 to 24:00. That is, the operation hour of the machine 1 is set to the hour 0:00 to 24:00 based on the extracted times. Thus, even if a non-operation hour exists in the time period from 0:00 to 24:00, the operation hour merging processing unit 222 neglects it.

In the following Step S305, the operation hour merging processing unit 222 increases the value of i by 1 (i=2). Then, the processing returns back to the loop following Step S302.

In a case of “i=2”, the condition “i≦N” (2≦4) in Step S302 is met. In Step S303, the operation hour merging processing unit 222 lists the operation hours of the machine 1 in order of ID.

In Step S303, the operation hour merging processing unit 222 lists the operation hours of the machine 2 as follows.

(1) hour 0:00 to 4:00

(2) hour 8:00 to 12:00

(3) hour 12:00 to 16:00

(4) hour 20:00 to 24:00

In Step S304, as in the case of the machine 1, the operation hour merging processing unit 222 extracts an operation start time 0:00 of the hour 0:00 to 4:00 and an operation end time 24:00 of the hour 20:00 to 24:00 and sets the hour 0:00 to 24:00 as a new operation hour. The machine 2 also is determined to operate constantly, which is different from the case of the first merging processing.

In the following Step S305, the operation hour merging processing unit 222 increases the value of i by 1 (i=3). Then, the processing returns back to the loop following Step S302.

The operation hour merging processing unit 222 updates the operation hours of the machine 3 and the machine 4 in a similar manner. That is, in the cases of “i=3” and “i=4”, the operation hour merging processing unit 222 updates the operation hour in a similar manner.

When “i=5” after completion of the processing with regard to the machine 4, the status in Step S202 is “i=5, N=4” and “i>N” (5>4). Since the condition “i≦N” is not met, the operation hour merging processing unit 222 terminates the whole processing.

As a result, the operation hour merging result for each machine (VM) is obtained as shown in the table in FIG. 8B.

The processing device 20 outputs the obtained operation hour merging result as the operation plan to the output device 30. Alternatively, the processing device 20 may output an instruction (command) or a signal based on the obtained operation hour determination result as the operation plan to the output device 30.

The reason why the result with regard to the machine 2 (VM-2) is different between the first merging processing and the second merging processing is that an hour during which the machine needs not to be operated exists between hours during which the machine needs to be operated. According to the second merging processing, the machine is operated even in an hour during which the machine needs not to be operated, in return for saving of the power-on/off operations, which causes extra power consumption. Which of the first merging processing and the second merging processing is to be selected depends on which of the power operation costs/risk and the power costs is to be saved preferentially.

By the above-described procedure, it is possible to further reduce operation costs and risk associated with the power-on and the power-off.

It should be noted that the exemplary embodiments described above can be implemented in combination.

The present invention is applicable to a device or a system for making an operation plan of serves in a data center where a large number of servers operate.

[Features of the Present Invention]

A machine operation plan creation device according to the present invention is characterized by having an operation hour determination processing unit configured to compare a machine ID numbered in order starting from 1 with an hourly required machine count and to determine, if the machine ID is not larger, that the machine needs to be operated.

Moreover, the machine operation plan creation device according to the present invention is characterized by further having an operation hour merging processing unit configured to merge, if each machine has a plurality of operation hours, the plurality of operation hours to reduce a number of the operation hours.

Moreover, the machine operation plan creation device according to the present invention is characterized in that if two operation hours are temporally continuous, the above-mentioned operation hour merging processing unit merges the two operation hours into a new operation hour.

Moreover, the machine operation plan creation device according to the present invention is characterized in that the above-mentioned operation hour merging processing unit extracts a start time of a first hour and an end time of a last hour from the plurality of operation hours and sets a time period from the start time to the end time as a new operation hour.

Moreover, the machine operation plan creation device according to the present invention is characterized by further having a maximum required machine count calculation unit configured to calculate a maximum required machine count from a list of the hourly required machine count.

While the invention has been particularly shown and described with reference to exemplary embodiments thereof, the invention is not limited to these exemplary embodiments. The invention may be modified and changed without departing from the scope and spirit of the invention.

<Supplementary Note>

It should be noted that this application is based upon and claims the benefit of priority from Japanese patent application No. 2010-069229, the disclosure of which is incorporated herein in its entirety by reference.

1. A machine operation plan creation device comprising:
an hourly required machine count storage unit configured to store an hourly required machine count; and
an operation hour determination processing unit configured to compare a machine identifier numbered in order starting from 1 with said hourly required machine count and to determine, if said machine identifier is not larger, that the machine associated with said machine identifier needs to be operated.

2. The machine operation plan creation device according to claim 1, further comprising: an operation hour merging processing unit configured to merge, if there is a plurality of operation hours with respect to each machine, said plurality of operation hours to reduce a number of said operation hours.

3. The machine operation plan creation device according to claim 2,
wherein if two operation hours among said plurality of operation hours are temporally continuous, said operation hour merging processing unit merges said two operation hours into a new operation hour.

4. The machine operation plan creation device according to claim 2,
wherein said operation hour merging processing unit extracts a start time of a first hour and an end time of a last hour from said plurality of operation hours and sets a time period from said start time to said end time as a new operation hour.

5. The machine operation plan creation device according to claim 1, further comprising: a maximum required machine count calculation unit configured to calculate a maximum required machine count from said hourly required machine count,
wherein said operation hour determination processing unit compares said machine identifier with said maximum required machine count and outputs, if said machine identifier is larger, a processing result.

6. A machine operation plan creation method performed by a computer, comprising:
comparing a machine identifier numbered in order starting from 1 with an hourly required machine count; and
determining, if said machine identifier is not larger, that the machine associated with said machine identifier needs to be operated.

7. The machine operation plan creation method according to claim 6, further comprising: merging, if there is a plurality of operation hours with respect to each machine, said plurality of operation hours to reduce a number of said operation hours.

8. The machine operation plan creation method according to claim 7, further comprising: merging, if two operation hours among said plurality of operation hours are temporally continuous, said two operation hours into a new operation hour in order to reduce the number of said operation hours.

9. The machine operation plan creation method according to claim 7, further comprising: extracting a start time of a first hour and an end time of a last hour from said plurality of operation hours and setting a time period from said start time to said end time as a new operation hour in order to reduce the number of said operation hours.

10. A machine operation plan creation program that causes a computer to execute the machine operation plan creation method according to claim 6.
